(19) United States
(12) Patent Application Publication
(10) Pub. No.: US 2019/0335077 A1
(43) Pub. Date: Oct. 31, 2019

(54) SYSTEMS AND METHODS FOR IMAGE CAPTURE AND PROCESSING

(71) Applicant: Ocusell, LLC, Covington, KY (US)

(72) Inventors: Hayden Rieveschl, Covington, KY (US); Brian Burgess, Covington, KY (US); Julia Sharkey, Covington, KY (US)

(21) Appl. No.: 16/379,011

(22) Filed: Apr. 9, 2019

Related U.S. Application Data
(60) Provisional application No. 62/727,246, filed on Sep. 5, 2018.
(60) Provisional application No. 62/662,498, filed on Apr. 25, 2018.

(51) Int. Cl. H04N 5/235; H04N 9/73; H04N 5/232; G06T 7/90; H04N 5/238

(52) U.S. Cl. CPC H04N 5/2352; H04N 5/2353; H04N 9/735; H04N 5/23212; G06T 2207/10148; H04N 5/238; H04N 5/23222; G06T 2207/20221; G06T 7/90

(57) ABSTRACT

Systems and methods for image processing. The methods comprise: obtaining, by a computing device, a plurality of exposure sequences, each said exposure sequence comprising a plurality of captured images captured sequentially in time at different exposure settings; respectively fusing, by the computing device, the plurality of captured images of said exposure sequences to create a plurality of fused images; and performing operations by the computing device to stitch together the plurality of fused images to create a combined image. The plurality of captured images, the plurality of fused images and the combined image are created using at least the same exposure parameters and white balance correction algorithm parameters.

### CROSS-REFERENCE TO RELATED APPLICATIONS

The present application claims the benefit of U.S. Patent Application Ser. No. 62/662,498 filed Apr. 25, 2018 and U.S. Patent Application Ser. No. 62/727,246 filed Sep. 5, 2018. Each of the foregoing patent applications is hereby incorporated by reference in its entirety.

### FIELD

This document relates generally to imaging systems. More particularly, this document relates to systems and methods for image capture and processing.

### BACKGROUND

Some current Portable Electronic Devices (“PED”) contain advanced storage, memory and optical systems. The optical systems are capable of capturing images at a very high Dots Per Inch (“DPI”). This allows a user to capture images of great quality where quality is assessed by the DPI. From a photographic standpoint, DPI constitutes one of many measures of image quality. PED cameras typically perform abysmally in other measures of quality (such as Field Of View (“FOV”), color saturation and pixel intensity range) which results in low (or no) contrast in areas of the photograph which are significantly brighter or darker than the median (calculated) light level.

### SUMMARY

The present disclosure concerns implementing systems and methods for image processing. The methods comprise: obtaining, by a computing device, a plurality of exposure sequences, each said exposure sequence comprising a plurality of captured images captured sequentially in time at different exposure settings; respectively fusing, by the computing device, the plurality of captured images of said exposure sequences to create a plurality of fused images; and performing operations by the computing device to stitch together the plurality of fused images to create a combined image. The plurality of captured images, the plurality of fused images and the combined image are created using at least the same exposure parameters and white balance correction algorithm parameters.

In some scenarios, the methods also comprise: receiving a first user-software interaction for capturing an image; and retrieving exposure parameters, white balance correction algorithm parameters, a number of images that are to be contained in an exposure sequence, and fusion parameter weights from a datastore, in response to the first user-software interaction. At least the exposure parameters are used to determine a middle exposure level for an exposure range that is to be used for capturing the plurality of exposure sequences. Exposure range values are determined using the middle exposure level. At least one focus request is created with the white balance correction algorithm parameters and the exposure range values. A plurality of requests for image capture are created using the exposure range values and the white balance correction algorithm parameters. A camera is focused in accordance with the at least one focus request. A plurality of images for each of the exposure sequences is captured in accordance with the plurality of requests for image capture. A format of each captured image may be transformed or converted, for example, from a YUV format to an RGB format. The plurality of images for each of the exposure sequences may also be aligned or registered.

In those or other scenarios, the plurality of fused images are created by: forming a grid of pixel values for each of the plurality of captured images in each said exposure sequence; determining at least one quality measure value for each pixel value in each said grid; assigning a fusion parameter weight to each pixel in each said captured image based on the at least one quality measure; building a scalar-valued weight map for each pixel location of said plurality of captured images using the fusion parameter weights; computing a weighted average for each said pixel location based on the scalar-valued weight map and the pixel values of the pixels in the plurality of captured images. The at least one quality measure value may include, but is not limited to, an absolute value, a standard deviation value, a saturation value, or a well-exposed value.

In those or other scenarios, the combined image is created by: identifying features in the plurality of fused images; generating descriptions for the features; using the descriptions to detect matching features in the plurality of fused images; comparing the matching features to each other; warping a position of each pixel in the plurality of fused images to a projected position in the combined image, based on results of said comparing; and adding the plurality of fused images together.

### DETAILED DESCRIPTION OF THE DRAWINGS

The present solution will be described with reference to the following drawing figures, in which like numerals represent like items throughout the figures.

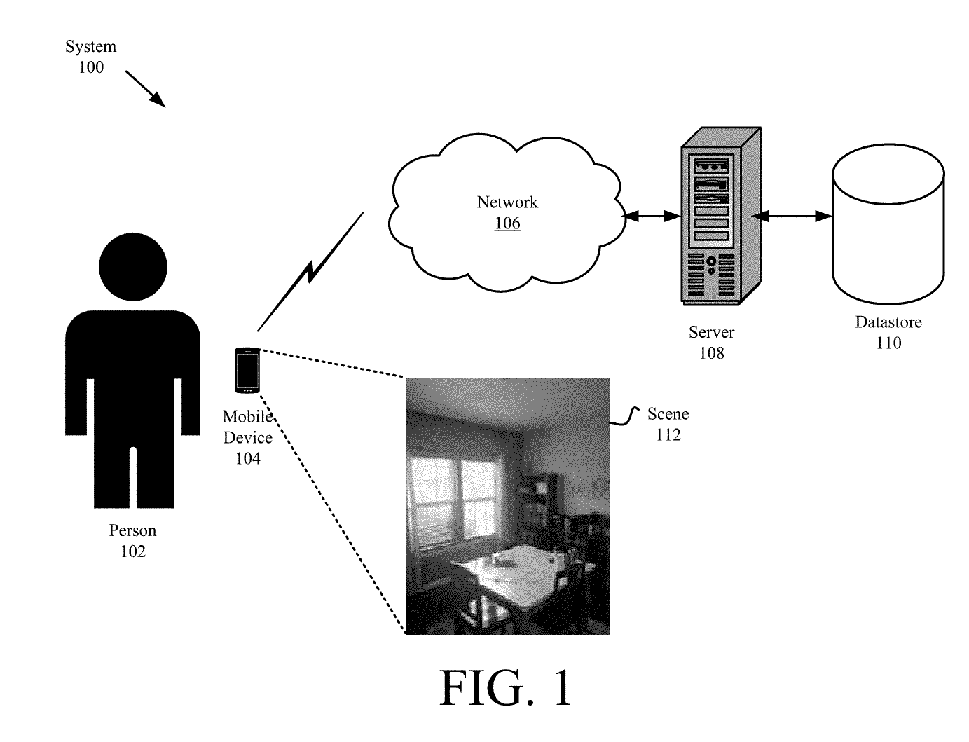

FIG. 1 is an illustration of an illustrative system implementing the present solution.

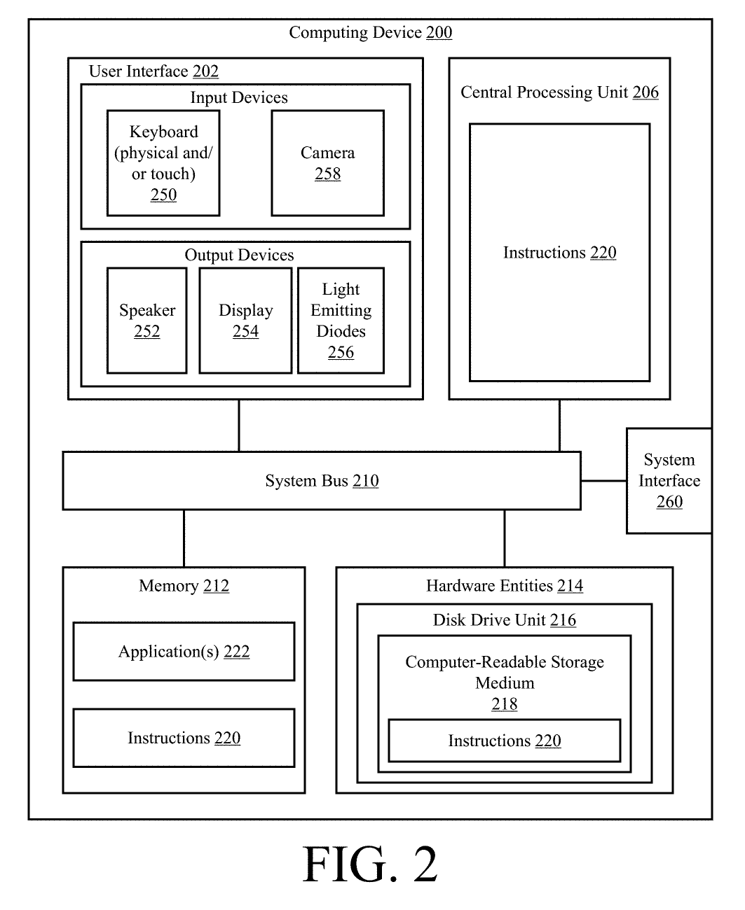

FIG. 2 is a block diagram of an illustrative computing device.

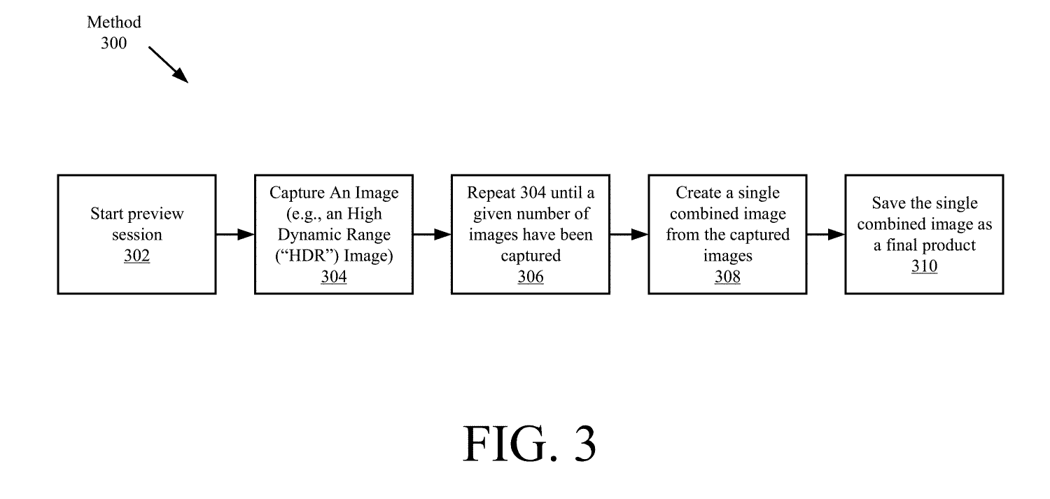

FIG. 3 is a functional block diagram showing a method for generating a combined image from images defining two or more exposure sequences.

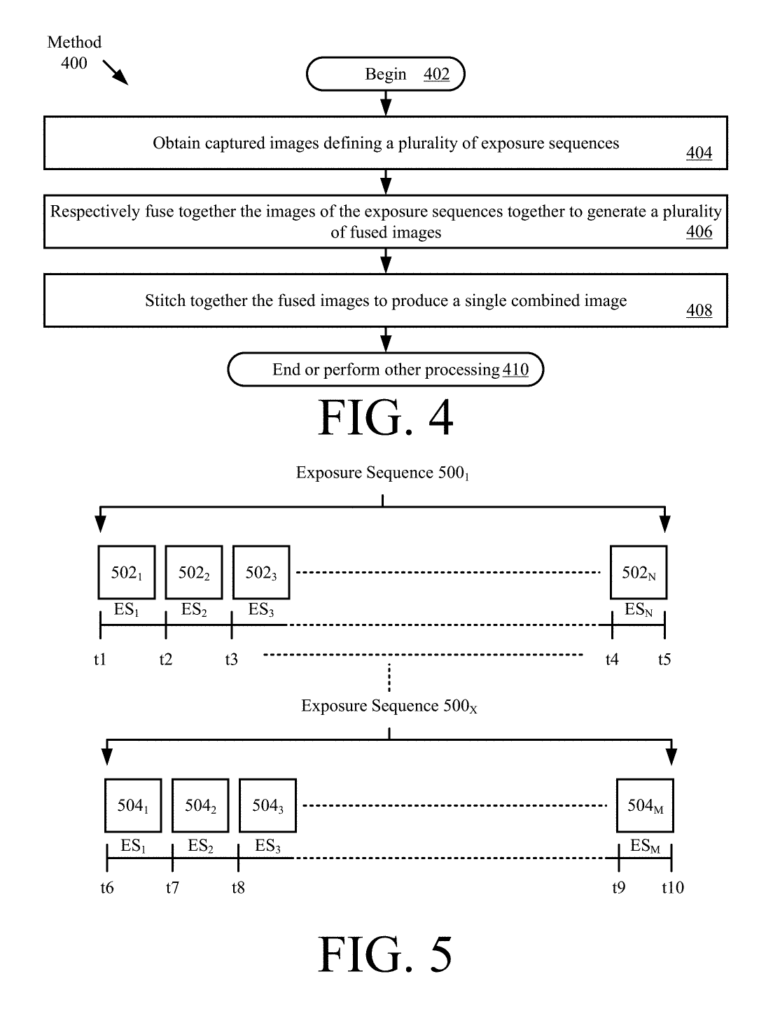

FIG. 4 is a flow diagram of an illustrative method for generating a single combined image from images defining two or more exposure sequences.

FIG. 5 is an illustration that is useful for understanding exposure sequences.

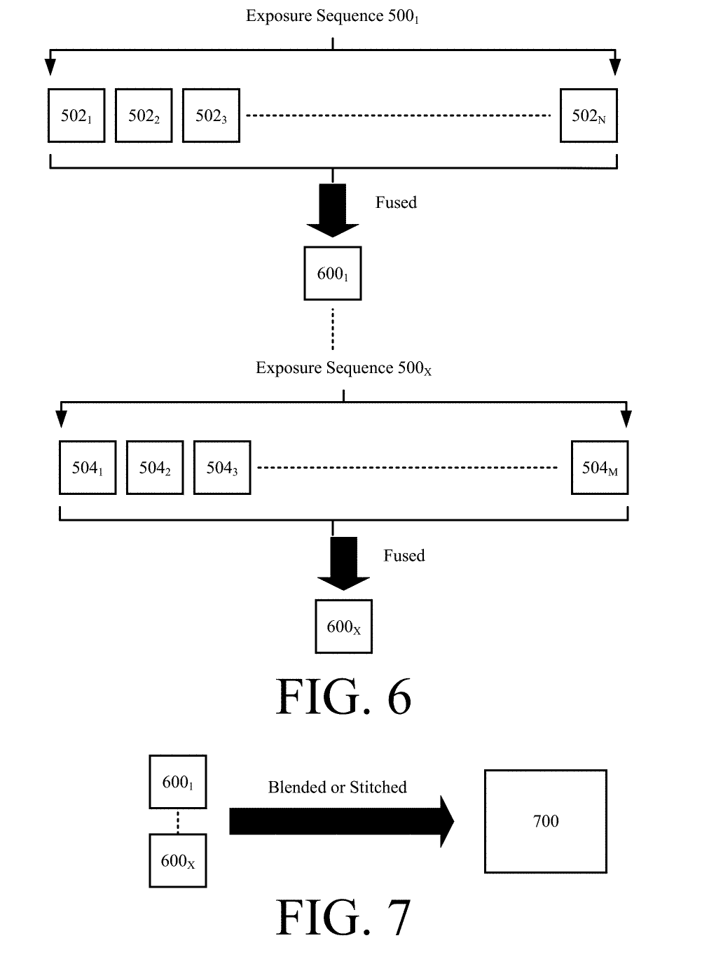

FIG. 6 is an illustration that is useful for understanding how fused images are created.

FIG. 7 is an illustration that is useful for understanding how a single combined image is created.

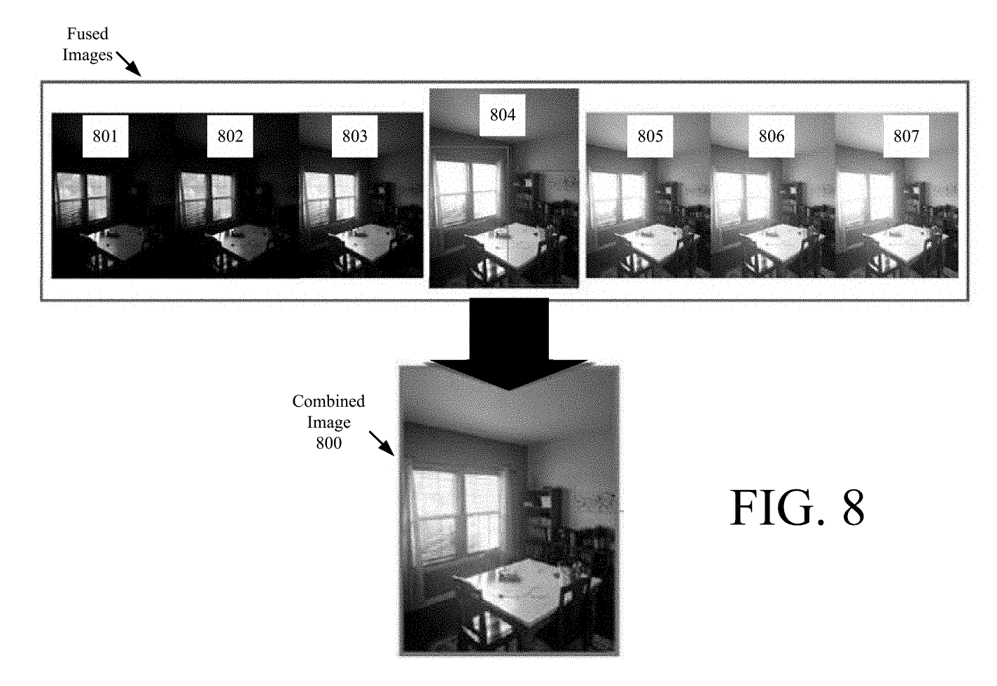

FIG. 8 is an illustration that is useful for understanding how a single combined image is created.

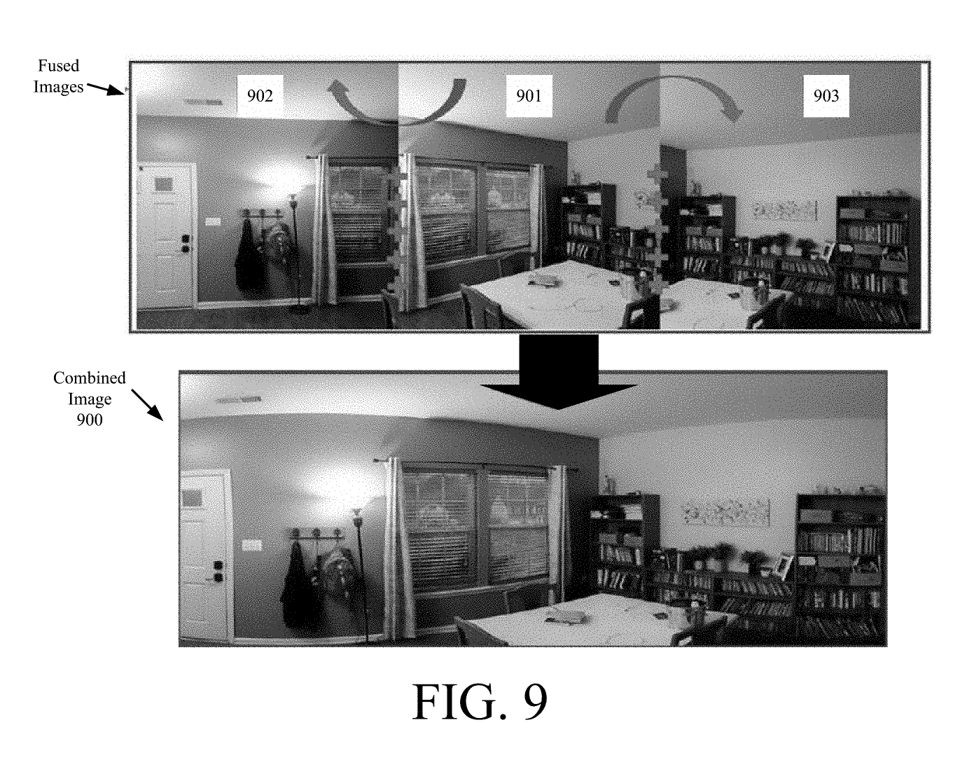

FIG. 9 is an illustration that is useful for understanding how a single combined image is created.

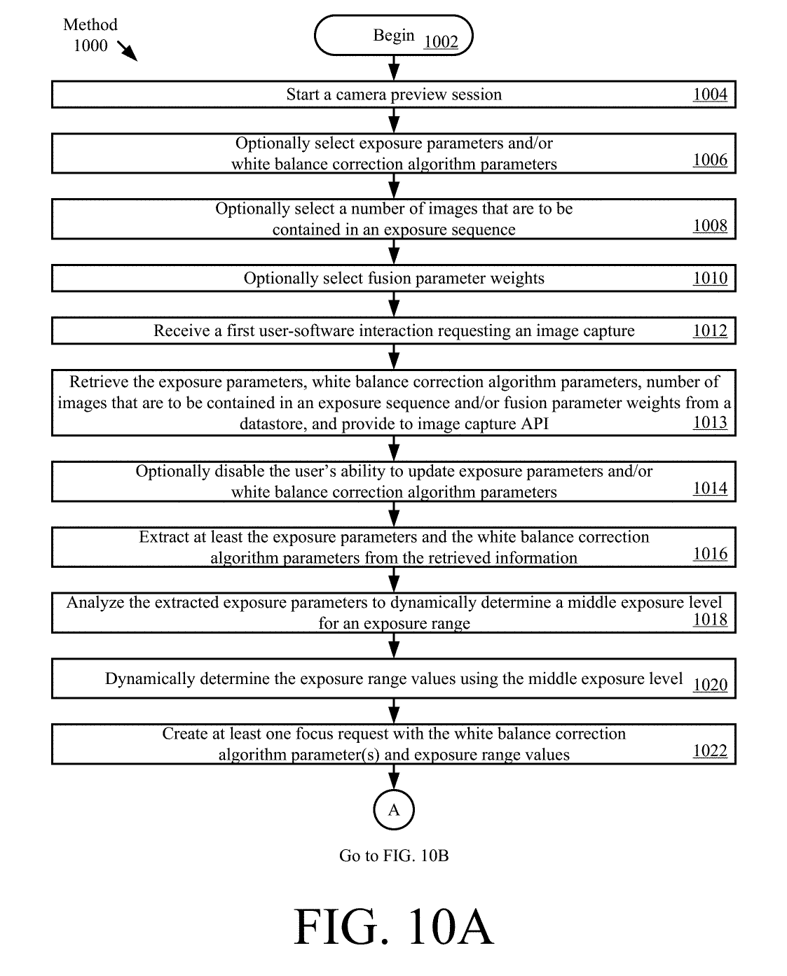

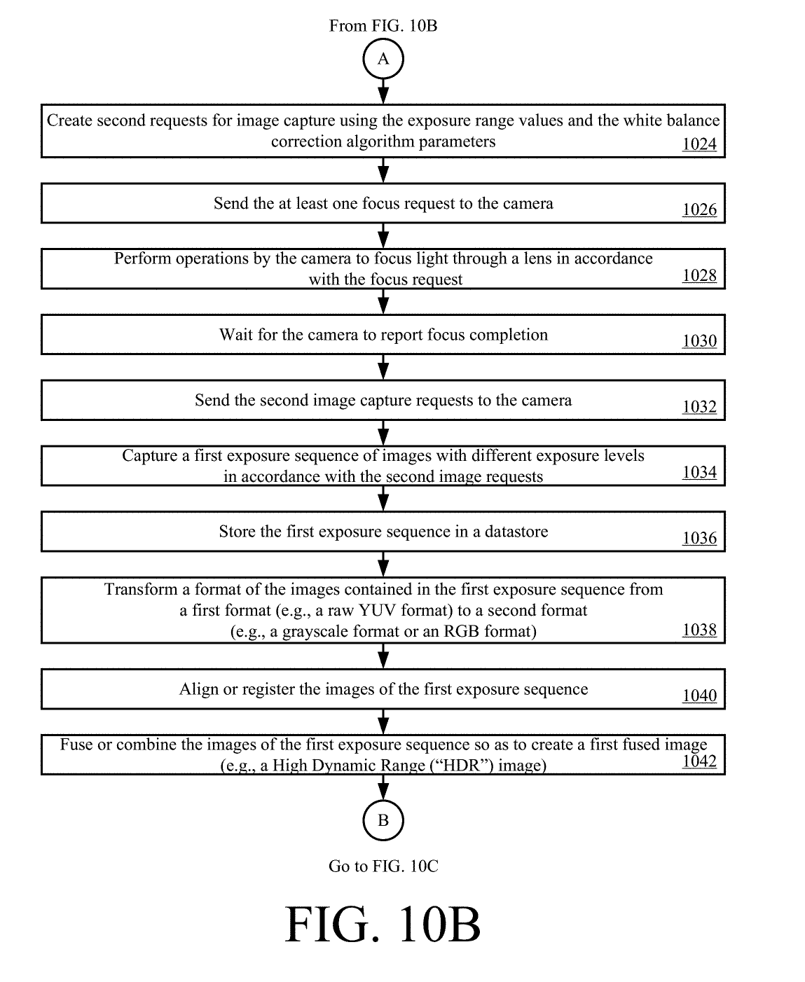

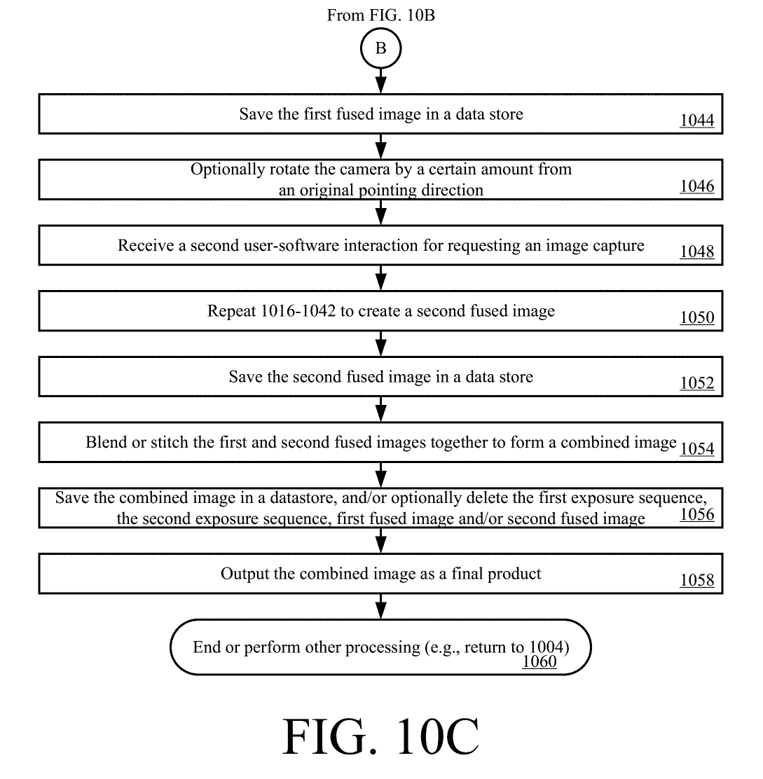

FIGS. 10A-10C (collectively referred to herein as “FIG. 10”) provided a flow diagram of an illustrative method for processing images.

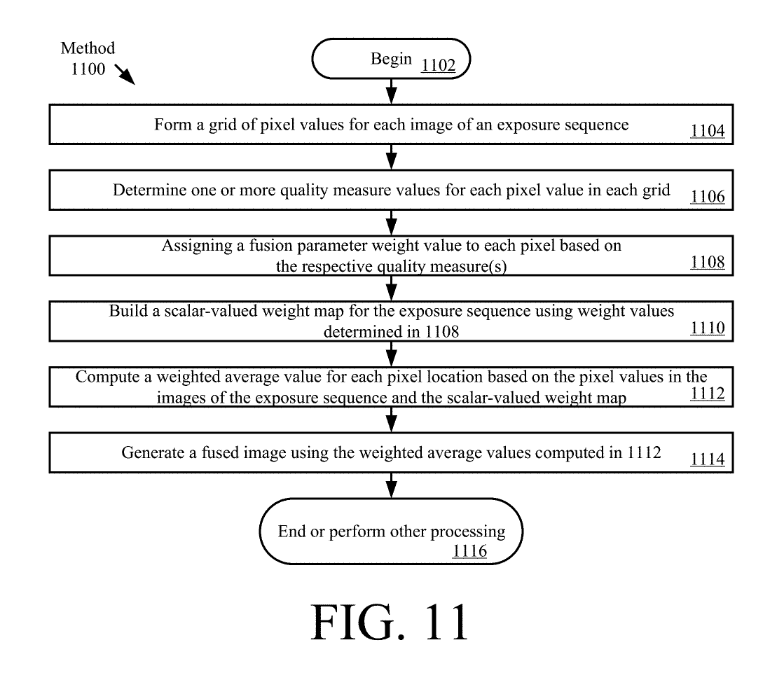

FIG. 11 is a flow diagram that is useful for understanding a novel exposure fusion algorithm.

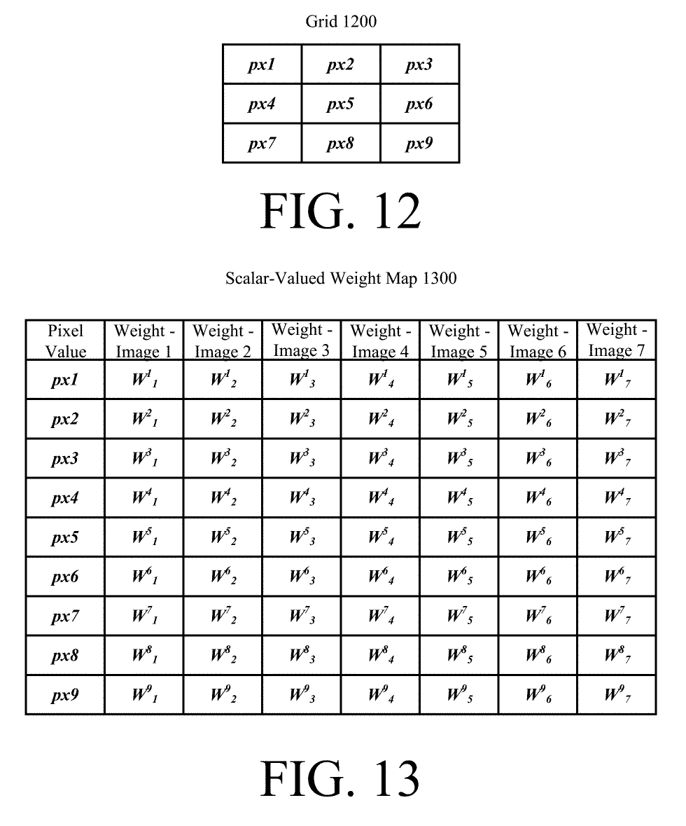

FIG. 12 is an illustration of an illustrative grid.

FIG. 13 is an illustration of an illustrative scalar-valued weight map.

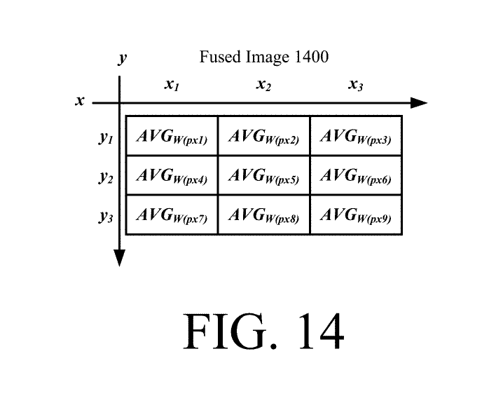

FIG. 14 is an illustration of an illustrative fused image.

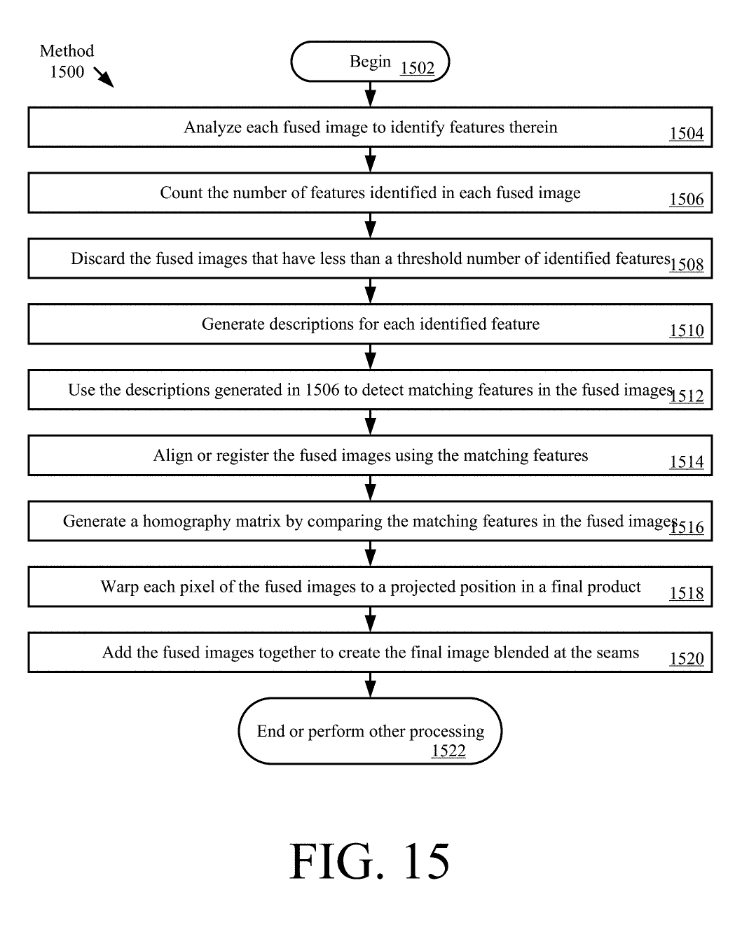

FIG. 15 is a flow diagram of an illustrative method for blending or stitching together fused images to form a combined image.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present disclosure generally concerns implementing systems and methods for using hardware (e.g., camera, memory, processor and/or display screen) of a mobile device (e.g., a smart phone) for image capture and processing. In response to each image capture request, the mobile device performs operations to capture a first set of images and to fuse the images of the first set together so as to form a first fused image. A user of the mobile device is then guided to another location where a second set of images is to be captured. Once captured, the second set of images are fused together so as to form a second fused image. This process may be repeated any number of times selected in accordance with a particular application. Once all sets of images are obtained, the mobile device performs operations to combine the fused images together so as to form a single combined image. The single combined image is then exported and saved in a memory of the mobile device.

The present solution is achieved by providing a system or pipeline that combines the methods that an expert photographer would use without the need for an expensive, advanced camera, a camera stand and advanced information processing systems.

Referring now to FIG. 1, there is provided an illustration of a system 100 implementing the present solution. System 100 comprises a mobile device 104, a network 106, a server 108, and a datastore 110. The mobile device 104 is configured to capture images of a scene 112, and process the captured images to create a single combined image. The captured images can include, but are not limited to, High Dynamic Range (“HDR”) images. The single combined image includes, but is not limited to, a panoramic image. The manner in which the single combined image is created will be discussed in detail below. The mobile device 104 can include, but is not limited to, a personal computer, a tablet, and/or a smart phone. The mobile device 104 is also capable of wirelessly communicating information to and from the server 108 via network 106 (e.g., the Internet or Intranet). The sever 108 is operative to store information in the datastore 110 and/or retrieve information from the datastore 110. For example, the HDR images and/or the panoramic image is stored in datastore 110 for later reference and/or processing. The present solution is not limited to in this regard.

Referring now to FIG. 2, there is provided an illustration of an illustrative architecture for a computing device 200. Mobile device 102 and/or server 108 of FIG. 1 is(are) the same as or similar to computing device 200. As such, the discussion of computing device 200 is sufficient for understanding these components of mobile device 102 and/or server 108.

In some scenarios, the present solution is used in a client-server architecture. Accordingly, the computing device architecture shown in FIG. 2 is sufficient for understanding the particulars of client computing devices and servers.

Computing device 200 may include more or less components than those shown in FIG. 2. However, the components shown are sufficient to disclose an illustrative solution implementing the present invention. The hardware architecture of FIG. 2 represents one implementation of a representative computing device configured to provide an improved item return process, as described herein. As such, the computing device 200 of FIG. 2 implements at least a portion of the method(s) described herein.

Some or all components of the computing device 200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (“CPU”) 206, a system bus 210, a memory 212 connected to and accessible by other portions of computing device 200 through system bus 210, a system interface 260, and hardware entities 214 connected to system bus 210. The user interface can include input devices and output devices, which facilitate user-software interactions for controlling operations of the computing device 200. The input devices include, but are not limited, a camera 258 and a physical and/or touch keyboard 250. The input devices can be connected to the computing device 200 via a wired or wireless connection (e.g., a Bluetooth® connection). The output devices include, but are not limited to, a speaker 252, a display 254, and/or light emitting diodes 256. System interface 260 is configured to facilitate wired or wireless communications to and from external devices (e.g., network nodes such as access points, etc.).

At least some of the hardware entities 214 perform actions involving access to and use of memory 212, which can be a Radom Access Memory (“RAM”), a solid-state or disk driver and/or a Compact Disc Read Only Memory (“CD-ROM”). Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 220 for execution by the computing device 200 and that cause the computing device 200 to perform any one or more of the methodologies of the present disclosure.

In some scenarios, the hardware entities 214 include an electronic circuit (e.g., a processor) programmed for facilitating the creation of a combined image as discussed herein. In this regard, it should be understood that the electronic circuit can access and run address software application(s) 222 installed on the computing device 200. The functions of the software application(s) 222 are apparent from the discussion of the present solution. For example, the software application is configured to perform one or more of the operations described below in relation to FIGS. 4-7. Such operations include, but are not limited to, querying an underlying framework or operating system, requesting access to the camera 258, ascertaining acceptable exposure levels of the camera 258, initiating a preview session in which the camera 258 streams digital images to the display 254, receiving a user-software interaction requesting an image capture, extracting exposure parameters (e.g., sensitivity and sensor exposure time) and white balance correction algorithm parameters from the user initiated image capture request, analyzing the extracted exposure parameters to dynamically determine a middle exposure level for an exposure range, creating additional image capture requests using (1) the dynamically determined middle exposure level so that a greater dynamic range of image exposures is acquired than can be provided in a single captured image and (2) extracted white balance correction algorithm parameters so that artifacts are avoided on the final product resulting from shifts in the white balance correction algorithm parameters, causing images to be captured by the camera 258, causing captured images to be stored locally in memory 212 or remotely in a datastore (e.g., datstore 110 of FIG. 1), decoding the captured images, aligning or registering the captured images, and/or processing the decoded/aligned/registered images to generate fused images (e.g., HDR images), discarding the decoded/aligned/registered images after the fused images have been generated, and/or using the fused images to create a single combined image (e.g., a panorama image) representing a final product. Other operations of the software application(s) 222 will become apparent as the discussion continues.

Referring now to FIG. 3, there is provided a flow diagram of an illustrative method 300 for creating a combined image (e.g., a panorama image) using a plurality of captured images (e.g., HDR images). As shown in FIG. 3, a preview session is started in 302. The preview session can be started by a person (e.g., person 102) via a user-software interaction with a mobile device (e.g., mobile device 104 of FIG. 1). The user-software interaction can include, but is not limited to, the depression of a physical or virtual button, and/or the selection of a menu item. During the preview session, the digital images are streamed under the software application's control, the framework's control and/or the operating system's control. The preview session allows the user (e.g., person 102 of FIG. 1) to view the subject matter prior to image capture.

Upon completing the preview session, the user inputs a request for image capture (e.g., by depressing a physical or virtual button). In response to the image capture request, the mobile device performs operations to capture an image as shown by 304. Techniques for capturing images are known in the art, and therefore will not be described herein. Any technique for capturing images can be used herein without limitation. The image capture operations of 304 are repeated until a given number of images (e.g., one or more sets of 2-7 images) have been captured.

Once a trigger event has occurred, the captured images are used to create a single combined image (e.g., a panorama image) as shown by 308. The trigger event can include, but is not limited to, the capture of the given number of images, the receipt of a user command, and/or the expiration of a given period of time. The single combined image can be created by the mobile device and/or a remote server (e.g., server 108 of FIG. 1). The single combined image is then saved in a datastore (e.g., datastore 110 of FIG. 1 and/or memory 212 of FIG. 2) as a final product in 310.

Referring now to FIG. 4, there is provided a flow diagram of an illustrative method 400 for generating a single combined image. Method 400 can be implemented in block 308 of FIG. 3. Method 400 can be performed by a mobile device (e.g., mobile device 104 of FIG. 1) and/or a remote server (e.g., server 108 of FIG. 1).

Method 400 begins with 402 and continues with 404 where captured images defining a plurality of exposure sequences are obtained (e.g., from datastore 110 of FIG. 1 and/or memory 212 of FIG. 2). As shown in FIG. 5, each exposure sequence comprises a sequence of images (e.g., 2-7) captured sequentially in time at different exposure settings (e.g., overexposed settings, underexposed settings, etc.). For example, a first exposure sequence 500₁ comprises an image 502₁ captured at time t1 and exposure setting ES₁, an image 502₂ captured at time t2 and exposure setting ES₂, an image 502₃ captured at time t3 and exposure setting ES₃, . . . , and an image 502_{N} captured at time t4 and exposure setting ES_{N}. A second exposure sequence 500_{X} comprises an image 504₁ captured at time t6 and exposure setting ES₁, an image 5042 captured at time t7 and exposure setting ES₂, an image 504₃ captured at time t8 and exposure setting ES₃, . . . , and an image 504m captured at time t9 and exposure setting ES_{M}. Notably, X, N and M can be the same or different integers. Also, the amount of time between each image capture can be the same or different. The present solution is not limited to the particulars of this example. Each exposure sequence of images can include any number of images greater than or equal to two.

Notably, the exposure settings can be defined in a plurality of different ways. In some scenarios, the exposure settings are manually adjusted or selected by the user of the mobile device. In other scenarios, the exposure settings are pre-configured settings, or dynamically determined by the mobile device based on a plurality of factors. The factors include, but are not limited to, lighting and/or scene content. The scene content is detected by the mobile device using a neural network model or other machine learned information. Neural network based techniques and/or machine learning based techniques for detecting content (e.g., objects) in a camera's FOV are known in the art. Any neural network based technique and/or machine learning based technique can be used herein without limitation.

Referring again to FIG. 4, method 400 continues with 406 where the images of the exposure sequences are respectively fused together to generate a plurality of fused images. For example, as shown in FIG. 6, images 502₁, 502₁, 502₃, . . . , 502_{N} are fused together to generate fused image 600₁, and images 504₁, 504₁, 504₃, . . . , 504_{N} are fused together to generate fused image 600_{X}. The manner in which the images are fused together will become more evident as the discussion progresses. Still, it should be understood that the image fusion is achieved by: identifying unique features between the images 502₁, . . . , 502_{N}; and arranging the images 502₁, . . . , 502_{N} to form a mosaic based on the identified unique features.

In some scenarios, fusion parameter weights are used so that the images are combined together by factors reflecting their relative importance. The fusion parameter weights can be defined in a plurality of different ways. In some scenarios, the fusion parameter weights are manually adjusted or selected by the user of the mobile device. In other scenarios, the fusion parameter weights are pre-configured settings, or dynamically determined by the mobile device based on a plurality of factors. The factors include, but are not limited to, lighting and/or scene content (e.g., detected using a neural network model or other machine learned information).

Next in 408, the fused images are blended or stitched together to produce a single combined image. For example, as shown in FIG. 7, fused images 600₁, . . . , 600_{X} are stitched together to form combined image 700. Combined image 700 can include, but is not limited to, a panorama image. The combined image 700 provides a final product of higher quality across a larger range of subjects and lighting scenarios as compared to that of conventional techniques. The manner in which the fused images are blended or stitched together will become more evident as the discussion progresses. Subsequently, 410 is performed where method 400 ends or other processing is performed (e.g., return to 404).

An illustration of a combined image 800 is provided in FIG. 8. Combined image 800 is generated using seven fused images 801, 802, 803, 804, 805, 806, 807. The combined image 800 is reflective of the fused image 4 that has been blended or stitched together with the other fused images 1-3, 5-7. Notably, the combined image 800 does not comprise a panorama image.

An illustration of a combined image 900 is provided in FIG. 9. Combined image 900 is generated using three fused images 901, 902, 903. Image 901 represents the scene in the camera's FOV when pointing at a center point in the combined image 900. Image 902 represents the scene in the camera's FOV when the camera is rotated to the left of the center point, while image 903 represents the scene in the camera's FOV when the camera is rotated to the right of the center point. The three images 901, 902, 903 are blended or stitched together to create the combined image 900, which comprises or is similar to a panorama image.

Referring now to FIG. 10, there is provided a flow diagram of an illustrative method 1000 for processing images. Method 1000 begins with 1002 and continues with 1004 where a camera preview session is started. The preview session can be started by a person (e.g., person 102) via a user-software interaction with a mobile device (e.g., mobile device 104 of FIG. 1). The user-software interaction can include, but is not limited to, the depression of a physical or virtual button, and/or the selection of a menu item. During the preview session, the digital images are streamed under the software application's control, the framework's control and/or the operating system's control. The preview session allows the user (e.g., person 102 of FIG. 1) to view the subject matter prior to image capture. In this way, the user can find a center point for the final product.

Next in optional 1006-1010, various selections are made. More specifically, exposure parameters, white balance correction algorithm parameters, a number of images that are to be contained in an exposure sequence, and/or fusion parameter weights is(are) selected. The exposure parameters include, but are not limited to, a sensitivity parameter and a sensor exposure time parameter. The sensitivity parameter is also known as an ISO value that adjusts the sensitivity to light of the camera. The sensor exposure time parameter is also known as shutter speed that adjusts the amount of time the light sensor is exposed to light. The greater the value of ISO and exposure time the brighter the captured image will be. In some scenarios, the sensitivity and exposure parameter values are limited to the range supported by the particular type of mobile device being used to capture the exposure sequences during process 1000.

White balance correction algorithms are well known in the art, and therefore will not be described herein. Any white balance correction algorithm can be used herein. For example, a white balance correction algorithm disclosed in U.S. Pat. No. 6,573,932 to Adams et al. is used herein. The white balance correction algorithm is employed to adjust the intensities of the colors in the images. In this regard, the white balance correction algorithm generally performs chromatic adaptation, and may operate directly on the Y, U, V channel pixel values in YUV format scenarios and/or R, G and B channel pixel values in RGB format scenarios. The white balance correction algorithm parameters include, but are not limited to, an ambient lighting estimate parameter, a scene brightness parameter, a threshold parameter for what is acceptably off-gray, a gain value parameter for the Y or R channel, a gain value parameter for the U or G channel, a gain value parameter for the V or B channel, and/or a saturation level parameter.

As noted above, the fusion parameter weights can be defined in a plurality of different ways. In some scenarios, the fusion parameter weights are manually adjusted or selected by the user of the mobile device. In other scenarios, the fusion parameter weights are pre-configured settings, or dynamically determined by the mobile device based on a plurality of factors. The factors include, but are not limited to, lighting and/or scene content (e.g., detected using a neural network model or other machine learned information). In all cases, the fusion parameter weights include, but are not limited to, numerical values that are to be subsequently used to create a fused image. For example, the numerical values include 0.00, 0.25, 0.50, 0.75, and 1.00. The present solution is not limited in this regard. The fusion parameter weights can have any values in accordance with a particular application.

The selections of 1006-1010 can be made either (a) manually by the user of the mobile device based on his(her) analysis of the scene in the camera's FOV, or (b) automatically by the mobile device based in its automated analysis of the scene in the camera's FOV. In both scenarios (a) and (b), the values can be selected from a plurality of pre-defined values. In scenario (a), the user may be provided with the capability to add, remove and edit values. The selected values are stored in a datastore (e.g., datastore 110 of FIG. 1 and/or memory 212 of FIG. 2) for later use. These optional selections prevent color seams (i.e., differences in color between two or more images) in blended or stitched images (e.g., in images showing large, flat surfaces of a single hue).

Thereafter in 1012, the mobile device receives a first user-software interaction for requesting an image capture. Responsive to the first user-software interaction, the following information is retrieved in 1013 from memory: exposure parameters, white balance correction algorithm parameters, number of images that are to be contained in an exposure sequence, and/or the fusion parameter weights. The retrieved information is then provided to an image capture Application Programming Interface (“API”) of the mobile device.

Also in response to the first image capture request, 1014 is optionally performed where the user's ability to update exposure parameters and/or white balance correction algorithm parameters is disabled for a given period of time (e.g., until the final product has been created).

Next in 1016, at least the exposure parameters and the white balance correction algorithm parameters are extracted from the information retrieved in previous 1013. The extracted exposure parameters are analyzed in 1018 to dynamically determine a middle exposure level for an exposure range that is to be used for capturing an exposure sequence. For example, the middle exposure value is determined to be EV_{MIDDLE}=0. The present solution is not limited in this regard. In some scenarios, the middle exposure range value EV_{MIDDLE} can be an integer between −6 and 21. The middle exposure value EV_{MIDDLE} is then used in 1020 to determine the exposure range values EV_{Y} for subsequent image capture processes. For example, if the number of images that are to be contained in an exposure sequence is seven, then the exposure range values are determined to be EV₁=−3, EV₂=−2, EV₃=−1, EV₄=EV_{MIDDLE}=0, EV₅=1, EV₆=2, EV₇=3. The present solution is not limited in this regard. The exposure range values can include integer values between −6 and 21. In some scenarios, the exposure range values include values that are no more than 5% to 200% different than the middle exposure range value EV_{MIDDLE}.

In 1022, at least one focus request is created with the white balance correction algorithm parameter(s) and the exposure range values. The focus request(s) is(are) created to ensure images are in focus prior to capture. Focus requests are well known in the art, and therefore will not be described herein. Any known focus request format, algorithm or architecture can be used here without limitation. In some scenarios, a plurality of focus requests (e.g., 2-7) are created (i.e., one for each image of an exposure sequence) by requesting bias to an exposure algorithm in equal steps between a negative exposure compensation value (e.g., −12) and a positive exposure compensation value (e.g., 12).

Upon completing 1022, method 1000 continues with 1024 in FIG. 10B. As shown in FIG. 10B, 1024 involves creating second requests for image capture. These second image capture requests are created using the exposure range values (e.g., EV₁-EV_{A}) and the extracted white balance correction algorithm parameters (e.g., an ambient lighting estimate parameter, a scene brightness parameter, a threshold parameter for what is acceptably off-gray, a gain value parameter for the Y or R channel, a gain value parameter for the U or G channel, a gain value parameter for the V or B channel, and/or a saturation level parameter). The second image capture requests have the same white balance correction algorithm parameters, but different exposure range values. For example, a first one of the second image capture requests includes EV₁ and WB_{1-q}. A second one of the second image capture requests includes EV₂ and WB_{1-q}, and so on. q can be any integer value.

Once the second image capture requests have been created, method 1000 continues with 1026 where the focus request(s) is(are) sent to the camera (e.g., camera 258 of FIG. 2) of the mobile device (e.g., from a plug-in software application 222 of FIG. 2 to camera 258 of FIG. 2). In response to the focus request(s), the camera performs operations to focus light through a lens in accordance with the information contained in the focus request. Techniques for focusing a camera are well known in the art, and therefore will not be described herein. Any technique for focusing a camera can be used herein without limitation. The mobile device then waits in 1030 for the camera to report focus completion.

When focus completion is reported, the second image capture requests are sent to the camera (e.g., from a plug-in software application 222 of FIG. 2 to camera 258 of FIG. 2), as shown by 1032. In response to the second image requests, the camera performs operations to capture a first exposure sequence of images (e.g., exposure sequence 500₁ of FIG. 5) with different exposure levels (e.g., exposure levels EV₁-EV₇).

In some scenarios, the first exposure sequence of images comprise burst images (i.e., images captures at a high speed). In other scenarios, the images are captured one at a time, i.e., not in a burst image capture mode but in a normal image capture mode. Additionally or alternatively, the camera is re-focused prior to capturing each image of the first exposure sequence. Notably, in the later scenarios, the scene tends to change between each shot. The faster the images of an exposure sequence are captured, the less the scene changes between shots and the better the quality of the final product.

In 1036, the first exposure sequence is stored in a datastore (e.g., datastore 110 of FIG. 1 or memory 212 of FIG. 2). In 1038, the format of the images contained in the first exposure sequence is transformed from a first format (e.g., a raw YUV format) to a second format (e.g., a grayscale or RGB format). For example, the images are transformed from a YUV format to an RGB format. YUV and RGB formats are well known, and will not be described herein.

The images are then further processed in 1040 to align or register the same with each other. Techniques for aligning or registering images are well known in the art, and therefore will not be described herein. Any technique for aligning or registering images can be used herein. In some scenarios, the image alignment or registration is achieved using the Y values (i.e., the luminance values) of the images in the YUV format, the U values (i.e., the first chrominance component) of the images in the YUV format, the V values (i.e., the second chrominance component) of the images in the YUV format, the R values (i.e., the red color values) of the images in the RGB format, the G values (i.e., the green color values) of the images in the RGB format, or the B values (i.e., the blue color values) of the images in the RGB format. Alternatively, the RGB formatted images are converted into grayscale images. These conversions can involve computing an average of the R value, G value and B value for each pixel to find a grayscale value. In this case, each pixel has a single grayscale value associated therewith. These grayscale values are then used for image alignment or registration.

In some scenarios, the images of the first exposure sequence are aligned or registered by selecting a base image to which all other images of the sequence are to be aligned or registered. This base image can be selected as the image with the middle exposure level EV_{MIDDLE}. Once the base image is selected, each image is aligned or registered thereto, for example, using a median threshold bitmap registration algorithm. One illustrative median threshold bitmap registration algorithm is described in a document entitled “Fast, Robust Image Registration for Compositing High Dynamic Range Photographs from Handheld Exposures” written by Ward. Median threshold bitmap registration algorithms generally involve: identifying unique features in each image; comparing the identified unique features of each image pair to each other to determine if any matches exist between the images of the pair; creating an alignment matrix (for warping and translation) or an alignment vector (for image translation only) based on the differences between unique features in the images and the corresponding unique features in the base image; and applying the alignment matrix or vector to the images in the first exposure sequence (e.g., the RGB images). Each of the resulting images has a width and a height that is the same as the width and height of the base image.

Once the images have been aligned or registered with each other, 1042 is performed where the images are fused or combined together so as to create a first fused image (e.g., fused image 600₁ of FIG. 6). The first fused image includes an HDR image. A novel exposure fusion algorithm is used here to create the first fused image. The exposure fusion algorithm generally involves computing a desired image by identifying and keeping only the best parts in the first exposure sequence. This computation is guided by a set of quality metrics, which are consolidated into a scalar-valued weight map. The novel exposure fusion algorithm will be described in detail below in relation to FIG. 11.

Referring again to FIG. 10, method 1000 continues with 1044 of FIG. 10C. As shown in FIG. 10C, 1044 involves saving the first fused image in a data store (e.g., datastore 110 of FIG. 1 or memory 212 of FIG. 2). Next in 1046, the camera is optionally rotated by a certain amount from the original pointing direction. Thereafter in 1048, the mobile device receives a second user-software interaction for requesting an image capture. Responsive to the second user-software interaction, 1016-1042 are repeated to create a second fused image (e.g., fused image 600x of FIG. 6), as shown by 1050. In 1052, the second fused image is saved in a datastore (e.g., datastore 110 of FIG. 1 or memory 212 of FIG. 2). As noted above, two or more fused images may be created. In this regard, 1048-1052 can be iteratively repeated any number of times in accordance with a particular application.

Once the fused images are created, method 1000 continues with 1054 where the same are blended or stitched together to form a combined image. The manner in which the fused images are blended or stitched together will be discussed in detail below in relation to FIG. 15. The combined image is then saved in a datastore (e.g., datastore 110 of FIG. 1 or memory 212 of FIG. 2) in 1056. Additionally or alternatively, the first exposure sequence, the second exposure sequence, the first fused image, and/or the second fused image is(are) deleted. The combined image is then output as the final product in 1058. Subsequently, 1060 is performed where method 1000 ends or other processing is performed (e.g., return to 1004).

Referring now to FIG. 11, there is provided a flow diagram of an illustrative method 1100 for creating a fused image in accordance with an exposure fusion algorithm. Method 1100 can be performed in 1042 of FIG. 10C.

As noted above, the exposure fusion algorithm generally involves computing a desired image by identifying and keeping only the best parts in the first exposure sequence. This computation is guided by a set of quality metrics, which are consolidated into a scalar-valued weight map.

As shown in FIG. 11, method 1100 begins with 1102 and continues with 1104 where a grid is formed for each digital image of an exposure sequence (e.g., exposure sequence 500₁ or 500ₓ of FIG. 5). The grid includes the pixel values for the given digital image in a grid format. An illustrative grid 1200 is shown in FIG. 12. In FIG. 12, px1 represents a value of a first pixel at a location (x₁, y₁) in a two-dimensional image, px2 represents a value of a second pixel at a location (x₂, y₁) in the two-dimensional image, and so on. The present solution is not limited to the particulars of the grid shown in FIG. 12. The grid can have any number of rows and columns selected in accordance with a given application.

Once the grids for all images in the exposure sequence are formed, 1106 is performed where one or more quality measure values for each pixel value in each grid is determined. The quality measure values include, but are not limited to, an absolute value, a standard deviation value, a saturation value, and/or a well-exposed value.

The absolute value ABS is calculated by applying a Laplacian filter to a corresponding pixel value in the grayscale version of the respective digital image. The Laplacian filter is defined by the following Mathematical Equation (1).

ABS=▾²f(x,y)=(∂²f(x,y))/∂x²)+(∂²f(x,y))/∂x²) (1)

where f(x, y) represents the divergence of the gradient, ∂ represents the divergence between two points, y represents the y-coordinate, and x represents the x-coordinate.

The standard deviation value is calculated as the square root of a variance. The standard deviation value is defined by the following Mathematical Equation (2).

std(pxj)=√var(pxj) (2)

where std(pxj) represents the standard deviation of a pixel value, pxj represents a pixel value for the j^{th} pixel, and var(pxj) represents the variance of a pixel value. The variance var(pxj) is calculated as the sum of a square of a difference between an average value of all pixels in an image and each pixel value of the image. The variance var(pxj) is defined by the following Mathematical Equation (3).

var(pxj)=Σ(px_{avg}−pxj)² (3)

where px_{avg} represents the average value for all pixels in the image.

The saturation value S is determined based on the standard deviation std(pxj) within the R, G and B channels for each pixel in the image. The saturation value is determined in accordance with the following process.

1. Normalize to 1 in accordance with the following Mathematical Equation (4).

N=r/255, g/255, b/255 (4)

where N is the normalized value, r is a red color value for a pixel, g is a green color value for the pixel, and b is a blue color value for the pixel.
2. Find a minimum for the r, g, b values and a maximum for the r, g, b values in accordance with the following Mathematical Equations (5) and (6).

min=min(r,g,b) (5)

max=max(r,g,b) (6)

3. If min is equal to max, then the saturation value S is zero (i.e., if min=max, then S=0).
4. Calculate a delta d between the minimum value min and the maximum value max in accordance with the following Mathematical Equation (7).

d=max−min (7)

5. If the average of the minimum value min and the maximum value max is less than or equal to 0.5, then the saturation value S in defined by the following Mathematical Equation (8).

S=dl(min+max) (8)

6. If the average of the minimum value min and the maximum value max is greater than 0.5, then the Saturation value S in defined by the following Mathematical Equation (9).

S=d/(2−min−max) (9)

The well-exposed value E is calculated based on the pixel intensity (i.e., how close to the middle of pixel intensity value range is a given pixel intensity). The well-exposed value E is computed by normalizing a pixel intensity value over an available intensity and choose the value that is closest to 0.5. The well-exposed value E is defined by the following Mathematical Equation (10).

E=abs(avg(r,g,b)−127.5) (10)

Returning again to FIG. 11, method 1100 continues with 1108. In order to determine which pixel in each image is the best pixel, a weight value W (also referred to herein as a “fusion parameter weight”) is assigned to each pixel in each image to determine how much of that pixel's value should be blended in a final image pixel's value at that location within a grid. The weight values are assigned to the pixels based on the respective quality measure(s). For example, a first pixel has a saturation value S equal to 0.3 and a standard deviation std equal to 0.7. A second pixel has a saturation value S equal to 0.2 and a standard deviation std equal to 0.6. Accordingly, a weight value will weigh each pixel with a saturation value of 2 and a standard deviation value of 1. Subsequently, the saturation value for each pixel will be multiplied by 2, and the standard deviation value for each pixel by 1. The two resulting values for each pixel are then added together to determine which weight value W should be assigned to that pixel.

P_{f}=(ABS·w_{ABS})+(std·w_{Std})+(S·w_{S})+(E·w_{E}) (11)

where P_{f} represents a weight value that should be assigned to the given pixel. In accordance with the above example, Mathematical Equation (6) can be rewritten for example as follows.

P_{fpixel1}=(0)+(0.7·1)+(0.3·2)+(0)=1.3

P_{fpixel2}=(0)+(0.6·1)+(0.2·2)+(0)=1.0

Once the raw weighting values P_{fpixel1}, P_{fpixel1}, etc. are determined, they are added together and normalized to one. As such, the first pixel is assigned a weight value W=1.3/2.3=0.57 (rounded up), and the second pixel is assigned a weight value W=1.0/2/3=0.44 (rounded up). The present solution is not limited to the particulars of this example.

Next in 1110, a scalar-valued weight map for the exposure sequence is built. An illustrative scalar-valued weight map for an exposure sequence with seven images is provided in FIG. 13. The scalar-valued weight map 1300 can be summarized as shown in the following Mathematical Equations (12) in which numerical values have been provided for each weight.

px1=[W¹₁,W¹₂,W¹₃,W¹₄,W¹₅,W¹₆,W¹₇]=[0.00, 0.00, 0.25, 0.50, 0.25, 0.00, 0.00]

px2=[W²₁,W²₂,W²₃,W²₄,W²₅,W²₆,W²₇]=[0.10, 0.20, 0.10, 0.50, 0.05, 0.05, 0.00] (12)

where W¹₁ represents the weight assigned to the value px1 of a first pixel at a location (x₁, y₁) in a first two-dimensional image of the exposure sequence, W¹₂ represents the weight assigned to the value px1 of a first pixel at a location (x₁, y₁) in a second two-dimensional image of the exposure sequence, W¹₃ represents the weight assigned to the value px1 of a first pixel at a location (x₁, y₁) in a third two-dimensional image of the exposure sequence, W¹₄ represents the weight assigned to the value px1 of a first pixel at a location (x₁, y₁) in a fourth two-dimensional image of the exposure sequence, W¹₅ represents the weight assigned to the value px1 of a first pixel at a location (x₁, y₁) in a fifth two-dimensional image of the exposure sequence, W¹₆ represents the weight assigned to the value px1 of a first pixel at a location (x₁, y₁) in a sixth two-dimensional image of the exposure sequence, and W¹₇ represents the weight assigned to the value px1 of a first pixel at a location (x₁, y₁) in a seventh two-dimensional image of the exposure sequence. Similarly, W²₁ represents the weight assigned to the value px2 of a second pixel at a location (x₂, y₁) in a first two-dimensional image of the exposure sequence, W²₂ represents the weight assigned to the value px2 of a second pixel at a location (x2, y₁) in a second two-dimensional image of the exposure sequence, W²₃ represents the weight assigned to the value px2 of a second pixel at a location (x₂, y₁) in a third two-dimensional image of the exposure sequence, W²₄ represents the weight assigned to the value px2 of a second pixel at a location (x₂, y₁) in a fourth two-dimensional image of the exposure sequence, W²₅ represents the weight assigned to the value px2 of a second pixel at a location (x₂, y₁) in a fifth two-dimensional image of the exposure sequence, W²₆ represents the weight assigned to the value px2 of a second pixel at a location (x₂, y₁) in a sixth two-dimensional image of the exposure sequence, and W²₇ represents the weight assigned to the value px2 of a second pixel at a location (x₂, y₁) in a seventh two-dimensional image of the exposure sequence, and so on.

As shown above in Mathematical Equations (12), there are seven weight values for each pixel location—one for each image of the exposure sequence. Notably, the sum of the weight values in each row is equal to 1 or 100%. Each weight value represents how much of a final pixel value at that location should depend on the pixel value for the given image. In the above example, the first, sixth and seventh images of the exposure sequence have weight values W¹₁, W¹₆, W¹₇ equal to zero for a first pixel value px1. Consequently, the first pixel values px1 in the first, sixth and seventh images will have no effect on the value px1 for the first pixel at a location (x₁, y₁) in the final fused image. The fourth image has a weight value W¹₄ equal to 0.50 which indicates that the first pixel's value should be half of the first pixel's value in the final fused image, whereas the third and fifth images have weight values W¹₃, W¹₅ equal to 0.25 which indicates that the first pixels' values should count towards (collectively) the other half of that first pixel's value of the final fused image.

Referring again to FIG. 11, method 1100 continues with 1112 where a weighted average for each pixel location is computed based on the pixel values of the images and the scalar-valued weight map. The following Mathematical Equations (13) described the computations of 1112.

AVG_{w(px1)}=((W¹₁/SW¹)·px1_{Image1})+((W¹₂/SW¹)·px1_{Image2})+((W¹₃/SW¹)·px1_{Image3})+((W¹₄/SW¹)·px1_{Image4})+((W¹₅/SW¹)·px1_{Image5})+((W¹₆/SW¹)·px1_{Image6}+((W¹₇/SW¹)·px1_{Image7})

AVG_{w(px2)}=((W²₁/SW²)·px1_{Image1})+((W²₂/SW²)·px1_{Image2})+((W²₃/SW²)·px1_{Image3})+((W²₄/SW²)·px1_{Image4})+((W²₅/SW²)·px1_{Image5})+((W²₆/SW²)·px1_{Image6}+((W²₇/SW²)·px1_{Image7}) (13)

where AVG_{w(px1)} represents a weighted average for the first pixel in the images of the exposure sequence, AVG_{w(px2)} represents a weighted average for the second pixel in the images of the exposure sequence, SW¹ represents a sum of the weights associated with px1 (i.e., W¹₁+W¹₂, W¹₃+W¹₄+W¹₅+W¹₆+W¹₇), SW² represents a sum of the weights associated with px2 (i.e., W²₁+W²₂+W²₃+W²₄+N²₅+W²₆+W²₇), px1_{Image1} represents the value for a first pixel in a first image of an exposure sequence, px1_{Image2} represents the value for a first pixel in a second image of an exposure sequence, px1_{Image3} represents the value for a first pixel in a third image of an exposure sequence, px1_{Image4} represents the value for a first pixel in a fourth image of an exposure sequence, px1_{Image5} represents the value for a first pixel in a fifth image of an exposure sequence, px1_{Image6} represents the value for a first pixel in a sixth image of an exposure sequence, px1_{Image7} represents the value for a first pixel in a seventh image of an exposure sequence, px2_{Image1} represents the value for a second pixel in a first image of an exposure sequence, etc., px2_{Image2} represents the value for a second pixel in a second image of an exposure sequence, px2_{Image3} represents the value for a second pixel in a third image of an exposure sequence, px2_{Image4} represents the value for a second pixel in a fourth image of an exposure sequence, px2_{Image5} represents the value for a second pixel in a fifth image of an exposure sequence, px2_{Image6} represents the value for a second pixel in a sixth image of an exposure sequence, and px2_{Image7} represents the value for a second pixel in a seventh image of an exposure sequence.

The above Mathematical Equations (13) can be re-written in accordance with the above example, as shown in the below Mathematical Equations (14).

AVG_{w(px1)}=0·px1_{Image1}+0·px1_{Image2}+0.25·px1_{Image3}+0.50·px1_{Image4}+0.25·px1_{Image5}+0·px1_{Image6}+0·px1_{Image7}

AVG_{w(px2)}=0.1·px2_{Image1}+0.2·px2_{Image2}+0.1·px2_{Image3}+0.5·px2_{Image4}+0.05·px2_{Image5}+0.05·px2_{Image6}+0·px2_{Image7} (14)

The present solution is not limited in this regard.

Referring again to FIG. 11, method 1100 continues with 1116 where a fused image is generated using the weighted average values computed in 1112. An illustration of an illustrative fused image 1400 is shown in FIG. 14. As shown in FIG. 14, the value for a first pixel at a location (x₁, y₁) in the fused image 1400 is equal to the weighted average value AVG_{w(px1)}. The value for a second pixel at a location (x₂, y₁) in the fused image 1400 is equal to the weighted average AVG_{w(px2)}, and so on. The present solution is not limited to the particulars of this example.

The above image fusion process 1100 can be thought of as collapsing a stack of images using weighted blending. The weight values are assigned to each pixel based on which region in an image it resides. Pixels in regions containing bright colors are assigned a higher weight value than pixels in regions having dull colors. For each pixel, a weighted average is computed based on the respective quality measure values contained in the scalar weight map. In this way, the images are seamlessly blended, guided by weight maps that act as alpha masks.

Referring now to FIG. 15, there is provided a flow diagram of an illustrative method for blending or stitching together at least two fused images to form a combined image. Method 1500 can be performed in 1054 of FIG. 10C.

As shown in FIG. 15, method 1500 begins with 1502 and continues with 1504 where each fused image (e.g., fused image 600₁, . . . , 600_{N} of FIG. 6) is processed to identify features therein. The term “feature”, as used herein, refers to a pattern or distinct structure found in an image (e.g., a point, an edge, a patch that differs from its immediate surrounding by texture, color and/or intensity). A feature may represent all or a portion of a chair, a door, a person, a tree, a building, etc. Next in 1506, the number of features identified in each fused image are counted. Any image that has less than a threshold number of identified features (e.g., 4) is discarded. The threshold number can be selected in accordance with any application.

Description of each identified feature in the remaining fused images are generated in 1510. The descriptions are used in 1512 to detect matching features in the remaining fused images. Next in 1514, the images are aligned or registered using the matching features. Techniques for aligning or registering images using matching features are well known in the art, and will not be described herein. Any known image aligning or registration technique using matching features can be used herein without limitation. For example, a wave alignment technique is used in some scenarios. Wave alignment comes from the fact that people do not often pivot from a center axis but from a translated axis. The present solution is not limited to the particulars of this example. In some scenarios, users are instructed to bend from the wrist, and a wave alignment technique is not employed.

Subsequently in 1516, a homography matrix is generated by comparing the matching features in the fused images. An illustrative homography matrix PH is defined by the following Mathematical Equation (15).

$$PH = [ \begin{matrix} & - {x}_{1} & & - {y}_{1} & & - 1 & 0 & 0 & 0 & {x}_{1} {x}_{1}^{′} & {y}_{1} {x}_{1}^{′} & {x}_{1}^{′} \\ 0 & 0 & 0 & & - {x}_{1} & & - {y}_{1} & & - 1 & {x}_{1} {y}_{1}^{′} & {y}_{1} {x}_{1}^{′} & {y}_{1}^{′} \\ & - {x}_{2} & & - {y}_{2} & & - 1 & 0 & 0 & 0 & {x}_{2} {x}_{2}^{′} & {y}_{2} {x}_{2}^{′} & {x}_{2}^{′} \\ 0 & 0 & 0 & & - {x}_{2} & & - {y}_{2} & & - 1 & {x}_{2} {y}_{2}^{′} & {y}_{2} {x}_{2}^{′} & {y}_{2}^{′} \\ & - {x}_{3} & & - {y}_{3} & & - 1 & 0 & 0 & 0 & {x}_{3} {x}_{3}^{′} & {y}_{3} {x}_{3}^{′} & {x}_{3}^{′} \\ 0 & 0 & 0 & & - {x}_{3} & & - {y}_{3} & & - 1 & {x}_{3} {y}_{3}^{′} & {y}_{3} {y}_{3}^{′} & {y}_{3}^{′} \\ & - {x}_{4} & & - {y}_{4} & & - 1 & 0 & 0 & 0 & {x}_{4} {x}_{4}^{′} & {y}_{4} {x}_{4}^{′} & {x}_{4}^{′} \\ 0 & 0 & 0 & & - {y}_{4} & & - {y}_{4} & & - 1 & {x}_{4} {y}_{4}^{′} & {y}_{4} {y}_{4}^{′} & {y}_{4}^{′}\end{matrix} ] [ \begin{matrix}h 1 \\ h 2 \\ h 3 \\ h 4 \\ h 5 \\ h 6 \\ h 7 \\ h 8 \\ h 9\end{matrix} ] \qquad ( 15 )$$

where PH represenst a matrix resulting from multiplying a first matrix by a second matrix, x₁ represents an x-coordinate of a first feature identified in the first image, x′1 represents an x-coordinate of a first feature identified in a second image, y₁ represents a y-coordinate of a first feature identified in the first image, y′1 represents a y-coordinate of a first feature identified in a second image, x2 represents an x-coordinate of a second feature identified in the first image, x′2 represents an x-coordinate of a second feature identified in a second image, y2 represents a y-coordinate of a second feature identified in the first image, y′2 represents a y-coordinate of a second feature identified in a second image, x3 represents an x-coordinate of a third feature identified in the first image, x′3 represents an x-coordinate of a third feature identified in a second image, y3 represents a y-coordinate of a third feature identified in the first image, y′3 represents an y-coordinate of a third feature identified in a second image, x4 represents an x-coordinate of a fourth feature identified in the first image, x′4 represents an x-coordinate of a fourth feature identified in a second image, y4 represents a y-coordinate of a fourth feature identified in the first image, y′4 represents an y-coordinate of a fourth feature identified in a second image, h1-h9 each represents a first unknown value for use in a subsequent image warping process. Once the values for h1-h9 are determined a 3×3 matrix Mwarping is built for use in warping an image. The 3×3 matrix Mwarping is structured in accordance with the following Mathematical Equation (16)

Mwarping=[[h1,h2,f3],[h4,h5,h6],[h7,h8,h9]] (16)

The first matrix is a 9×9 matix. The second matrix is a 1×9 matrix created for the corresponding coordinates in the image to be warped: [x1, y1, x2, y2, x3, y3, x4, y4, 1]. The 3×3 matrix Mwarping can be used to obtain the location of the pixel in the final panarama image as shown by the following Mathematical Equations (17) and (18).

x(out)=(x(in)*f1+y(in)*f2+f3)/(x(in)*f7+y(in)*f8+f9) (17)

y(out)=(x(in)*f4+y(in)*f5+f6)/(x(in)*f7+y(in)*f8+f9) (18)

wherein x(out) represents the x-axis coordinate for a pixel, y(out) represents the y-axis coordinate for the pixel, x(in) represents an input x-axis coordinate, y(in) represents an input y-axis coordinate, f1-f9 represent values with the 3×3 matrix Mwarping.

Once the warping matrix Mwarping is generated, each pixel of the fused images is warped to a projected position in a final product, as shown by 1518. For example, the values x(out) and y(out) are adjusted to the projected position in the final product.

In next 1520, the fused images are added together to create a final image blended at the seams. Techniques for adding images together are well known in the art, and therefore will not be described in detail herein. Any known image adding technique can be used herein without limitation. For example, a Laplacian pyramid blending technique is used herein due to its ability to preserve edge data while still blurring pixels. This results in smooth but unnoticeable transitions in the final product. Subsequently, 1522 is performed where method 1500 ends or other processing is performed.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for image processing, comprising:
obtaining, by a computing device, a plurality of exposure sequences, each said exposure sequence comprising a plurality of captured images captured sequentially in time at different exposure settings;
respectively fusing, by the computing device, the plurality of captured images of said exposure sequences to create a plurality of fused images; and
performing operations by the computing device to stitch together the plurality of fused images to create a combined image;
wherein the plurality of captured images, the plurality of fused images and the combined image are created using at least the same exposure parameters and white balance correction algorithm parameters.

2. The method according to claim 1, further comprising receiving a first user-software interaction for capturing an image.

3. The method according to claim 2, further comprising retrieving exposure parameters, white balance correction algorithm parameters, a number of images that are to be contained in an exposure sequence, and fusion parameter weights from a datastore, in response to the first user-software interaction.

4. The method according to claim 3, further comprising using at least the exposure parameters to determine a middle exposure level for an exposure range that is to be used for capturing the plurality of exposure sequences.

5. The method according to claim 4, further comprising determining exposure range values using the middle exposure level.

6. The method according to claim 5, further comprising creating at least one focus request with the white balance correction algorithm parameters and the exposure range values.

7. The method according to claim 6, further comprising creating a plurality of requests for image capture using the exposure range values and the white balance correction algorithm parameters.

8. The method according to claim 7, further comprising focusing a camera in accordance with the at least one focus request.

9. The method according to claim 8, further comprising capturing a plurality of images for each of the exposure sequences in accordance with the plurality of requests for image capture.

10. The method according to claim 9, further comprising aligning or registering the plurality of images for each of the exposure sequences.

11. The method according to claim 1, wherein the plurality of fused images are created by:
forming a grid of pixel values for each of the plurality of captured images in each said exposure sequence;
determining at least one quality measure value for each pixel value in each said grid;
assigning a fusion parameter weight to each pixel in each said captured image based on the at least one quality measure;
building a scalar-valued weight map for each pixel location of said plurality of captured images using the fusion parameter weights;
computing a weighted average for each said pixel location based on the scalar-valued weight map and the pixel values of the pixels in the plurality of captured images.

12. The method according to claim 1, wherein the combined image is created by:
identifying features in the plurality of fused images;
generating descriptions for the features;
using the descriptions to detect matching features in the plurality of fused images;
comparing the matching features to each other;
warping a position of each pixel in the plurality of fused images to a projected position in the combined image, based on results of said comparing; and
adding the plurality of fused images together.

13. A system, comprising:
a processor;
a non-transitory computer-readable storage medium comprising programming instructions that are configured to cause the processor to implement a method for image processing, wherein the programming instructions comprise instructions to:
obtain a plurality of exposure sequences, each said exposure sequence comprising a plurality of captured images captured sequentially in time at different exposure settings;
respectively fuse the plurality of captured images of said exposure sequences to create a plurality of fused images; and
stitch together the plurality of fused images to create a combined image;
wherein the plurality of captured images, the plurality of fused images and the combined image are created using at least the same exposure parameters and white balance correction algorithm parameters.

14. The system according to claim 13, wherein the programing instructions further comprise instructions to receive a first user-software interaction for capturing an image.

15. The system according to claim 14, wherein the programing instructions further comprise instructions to retrieve exposure parameters, white balance correction algorithm parameters, a number of images that are to be contained in an exposure sequence, and fusion parameter weights from a datastore, in response to the first user-software interaction.

16. The system according to claim 15, wherein the programing instructions further comprise instructions to use at least the exposure parameters to determine a middle exposure level for an exposure range that is to be used for capturing the plurality of exposure sequences.

17. The system according to claim 16, wherein the programing instructions further comprise instructions to determine exposure range values using the middle exposure level.

18. The system according to claim 17, wherein the programing instructions further comprise instructions to create at least one focus request with the white balance correction algorithm parameters and the exposure range values.

19. The system according to claim 18, wherein the programing instructions further comprise instructions to create a plurality of requests for image capture using the exposure range values and the white balance correction algorithm parameters.

20. The system according to claim 19, wherein the programing instructions further comprise instructions to cause a camera to be focused in accordance with the at least one focus request.

21. The system according to claim 20, wherein the programing instructions further comprise instructions to cause a plurality of images for each of the exposure sequences to be captured in accordance with the plurality of requests for image capture.

22. The system according to claim 21, wherein the programing instructions further comprise instructions to align or register the plurality of images for each of the exposure sequences.

23. The system according to claim 13, wherein the plurality of fused images are created by:
forming a grid of pixel values for each of the plurality of captured images in each said exposure sequence;
determining at least one quality measure value for each pixel value in each said grid;
assigning a fusion parameter weight to each pixel in each said captured image based on the at least one quality measure;
building a scalar-valued weight map for each pixel location of said plurality of captured images using the fusion parameter weights;
computing a weighted average for each said pixel location based on the scalar-valued weight map and the pixel values of the pixels in the plurality of captured images.

24. The system according to claim 13, wherein the combined image is created by:
identifying features in the plurality of fused images;
generating descriptions for the features;
using the descriptions to detect matching features in the plurality of fused images;
comparing the matching features to each other;
warping a position of each pixel in the plurality of fused images to a projected position in the combined image, based on results of said comparing; and
adding the plurality of fused images together.
